(19) United States
(12) Patent Application Publication
(10) Pub. No.: US 2006/0187404 A1
(43) Pub. Date: Aug. 24, 2006

(54) Eyeglasses with interchangeable decorative attachments

(76) Inventor: Nonu Ifergan, Mont-Royal (CA)

Correspondence Address: BLAKE, CASSELS & GRAYDON LLP, BOX 25, COMMERCE COURT WEST, 199 BAY STREET, SUITE 2800, TORONTO, ON, M5L 1A9, CA

(21) Appl. No.: 11/338,881

(22) Filed: Jan. 25, 2006

Related U.S. Application Data
(60) Provisional application No. 60/646,527, filed on Jan. 25, 2005.

(51) Int. Cl. G02C 5/00

(52) U.S. Cl. 351/41

(57) ABSTRACT

An eyeglass and a decorative attachment for mounting upon the eyeglass is provided. The eyeglass has a recess at each side portion with a magnetic member therein. The decorative attachment has a pair of bands separated by a nose plate which are contoured to follow the shape of the frame of the eyeglass. The decorative attachment has an plate at each end, each plate having a pin protruding therefrom. Each pin is sized to fit within corresponding recesses in the eyeglass and are made of a magnetically attractive material of opposite polarity to that of the magnetic member within the recess wherein magnetic attraction between the pins and the magnetic members will mount the decorative attachment upon the eyeglass.

### This application claims priority from United States Provisional Patent Application No. 60/646,527 filed Jan. 25, 2005.

### FIELD OF THE INVENTION:

The present invention relates to field of eyeglasses, and has particular utility for interchangeable eyeglass frames having a primary eyeglass frame and detachable auxiliary frames.

### DESCRIPTION OF THE PRIOR ART

Eyeglasses typically provide a pair of lenses, prescriptive and/or protective, that are supported on a user. The support for the eyeglasses typically includes a pair of temples that extend rearwardly from the lens and engage the ears of the user. Further support may be provided by a bridge that extends between the lenses and engages the nose of the user. In this way, a stable support for the lens is provided which may be adjusted to suit the particular needs of the user.

The temples and bridge may form part of a frame that also provides a support for the lenses. In this arrangement, the frame will extend about the lens to define a lens opening that holds the lens in the required position. The frame surrounding the lens opening may be designed for aesthetic appeal or may be relatively unobtrusive when formed from a transparent material or thin member.

Eyeglasses are typically worn on a daily basis, and in general, a user chooses eyeglasses, in particular the frames therefor, to suit their own style such that the eyeglasses will accommodate such a style. Despite a user's attempts to match an eyeglass style to their own style or wardrobe, the user may often prefer different frame styles or colours to suit different occasions, e.g. for complementing different clothes. However, eyeglasses, particularly prescriptive eyeglasses, may be expensive, and therefore it is generally infeasible to own multiple pairs of eyeglasses with an assortment of frame styles and/or colours.

It is therefore an object of the present invention to obviate or mitigate the above mentioned disadvantages.

### SUMMARY OF THE INVENTION

In one aspect, the present invention provides a decorative attachment for an eyeglass, the eyeglass comprising an eyeglass frame containing a pair of lenses separated by a bridge and a pair of side portions at respective ends thereof The attachment comprises an auxiliary frame sized to cover a portion of the eyeglass frame, and at least one magnetic member for supporting the attachment on the eyeglass through magnetic attraction therebetween.

In another aspect, the present invention provides an eyeglass device comprising a primary frame containing a pair of lenses separated by a bridge and a pair of side portions at respective ends of the primary frame, and a decorative attachment having an auxiliary frame sized to cover a portion of the primary frame and at least one magnetic member for supporting the attachment on the primary frame through magnetic attraction therebetween.

### BRIEF DESCRIPTION OF THE DRAWINGS

An embodiment of the invention will now be described by way of example only with reference to the appended drawings wherein:

FIG. 1 is a perspective view of an eyeglass with a mounted attachment.

FIG. 2 is an exploded perspective view of the eyeglass and attachment of FIG. 1.

FIG. 3 is an enlarged perspective view of a portion of the eyeglass and attachment.

FIG. 4 is an enlarged rear perspective view of a portion of the eyeglass.

FIG. 5 is a cross section of the eyeglass of FIG. 3 along the line V-V.

FIG. 6 is a perspective view of the eyeglass and attachment during assembly.

FIG. 7 is a perspective view of the eyeglass with an alternative attachment.

FIG. 8 is a rear perspective view of the eyeglass having an attachment mounted at the rear.

### DETAILED DESCRIPTION OF THE INVENTION

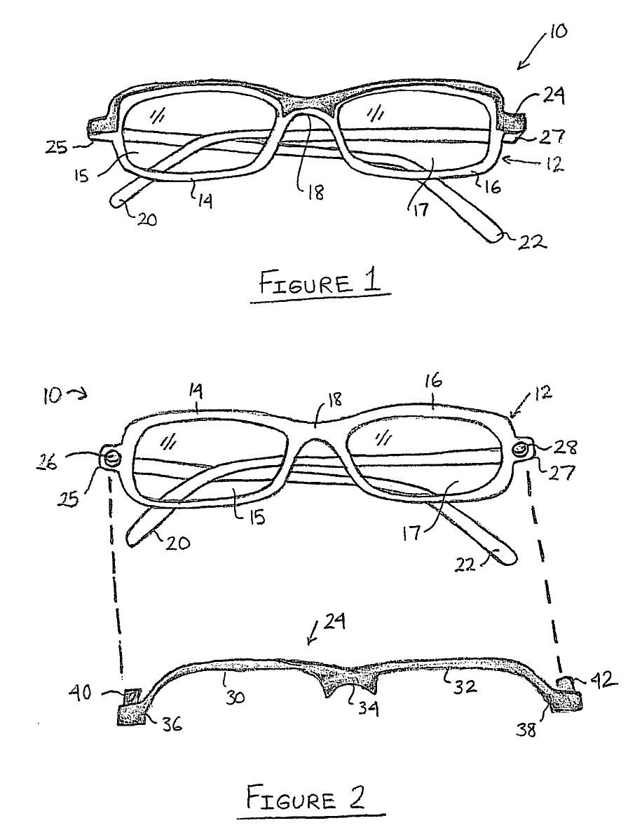

Referring therefore to FIG. 1, an eyeglass is generally denoted by numeral 10. The eyeglass 10 has a frame 12 with a first portion 14 and a second portion 16 which hold a first lens 15 and a second lens 17 respectively. The first portion 14 and second portion 16 are joined together and separated a distance from each other by a bridge 18 which is formed to rest upon a user's nose.

Extending outwardly from the first portion 14 is a first side portion 25 and extending outwardly from the second portion 16 is a second side portion 27. A first temple 22 is pivotally connected to the first side portion 25 and a second temple 20 is pivotally connected to the second side portion 27 allowing the temples 20, 22 to fold against the frame 12 as shown in FIG. 1.

In general, the frame 12 is a primary eyeglass frame containing the lenses 15, 17, which is capable of accommodating auxiliary frames, but may also be used on its own. For example, as shown in FIG. 1, the frame 12 enables magnetic attraction between itself and a decorative attachment 24, as will be explained more fully below.

In general, decorative attachments (such as attachment 24) are interchangeable eyeglass pieces that serve to modify and/or conceal at least a portion of the appearance of a primary frame (such as frame 12), e.g., by having a distinguishing shape, distinguishing colour, and/or any other variable aesthetic feature.

It will be appreciated that the side portions 25, 27 may be adapted for any suitable arrangement to enable magnetic attraction between the frame 12 and the attachment 24, and the examples shown herein are for illustrative purposes only.

The decorative attachment 24 is mounted upon the upper ridge of the frame 12 and covers the front surfaces of the side portions 25, 27 to partially conceal the frame 12 across its length with an integral piece having a distinguishing colour. In general, the attachment 24 is sized to seat itself flush with the front surface of the frame 12 in order to visibly modify the shape, colour and thus style of the frame 12. The frame 12 will typically comprise its own colour and style, which can be worn with or without the attachment 24. Therefore, the frame 12 may be used on its own on a regular basis and modified using a particular attachment 24 when desired. The attachment 24 may cover a portion of the frame (as shown in FIG. 1) or may entirely mask the frame 12 beneath. Preferably, the attachment 24 is thin and sized so as to not interfere with the hinged connection between temples 20, 22 and side portions 25, 27, nor interfere with bridge 18.

FIG. 2 shows the decorative attachment 24 dismounted from the eyeglass 10. The first side portion 25 has a first cylindrical recess 26 and the second side portion has a second cylindrical recess 28. It will be appreciated that the recesses 26, 28 may be any shape, and depth, and may be formed in any suitable surface of the frame 12, such as the forward facing surface (as shown) or the upwardly facing surface (not shown).

The attachment 24 has a first band 30 and a second band 32 whose shape generally corresponds to the upper ridge of the first portion 14 and second portion 16 respectively. The bands 30, 32 are integrally formed with a nose plate 34 and their shapes generally correspond to the front face of the bridge 18. Thus, in this example, the attachment 24 preferably provides a continuous band having a distinguishing colour covering an upper portion of the facing surface of frame 12 (including a contoured portion, e.g., plate 34 across nose piece 18). A first end plate 36 extends from the first band 30 and a second end plate 38 extends from the second band 32. In this example, each end plate 36 supports a magnetic member, where extending rearwardly from the first plate 36 is a first magnetic pin 40 and rearwardly from the second plate 38 is a second magnetic pin 42.

The pins 40, 42 are cylindrically shaped and are sized to substantially correspond to the first recess 26 and second recess 28 respectively. The pins 40, 42 may have magnetic members formed therein or may be made in part or entirely of a magnetic material. Alternatively, only the end faces of the pins 40, 42 may comprise magnetic properties. The pins 40, 42 provide a lateral connection to each side of the bridge 18 offering a stable support for the attachment 24 at the temples 20, 22. It will be appreciated that the attachment 24 may also be mounted to frame 12 through magnetic attraction between nose piece 18 and plate 34 (not shown).

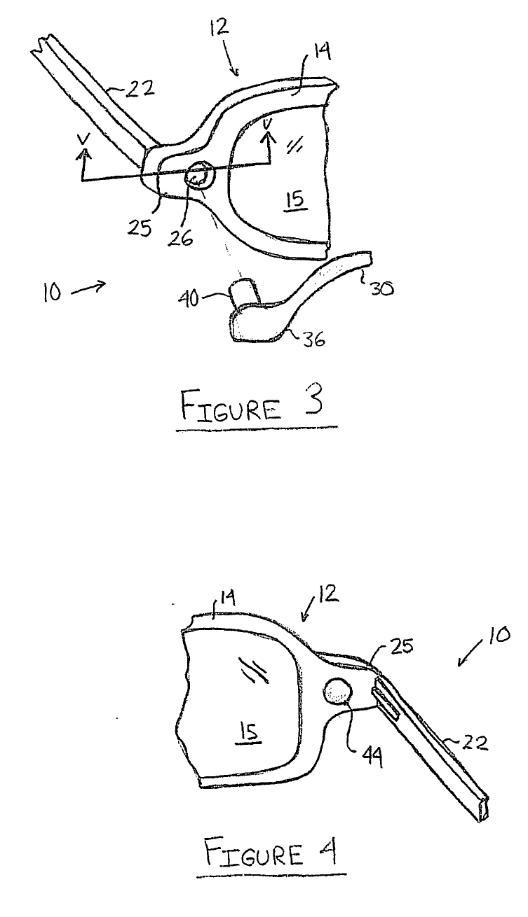

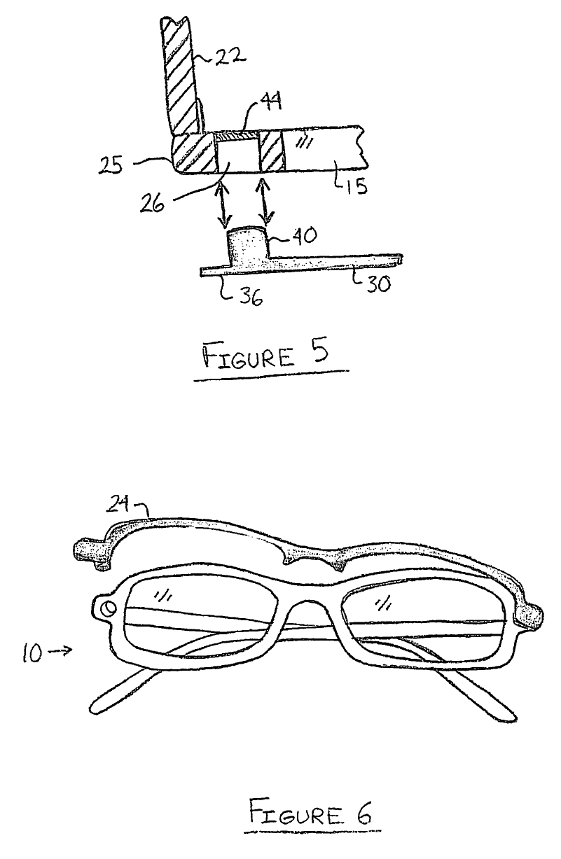

Referring now to FIGS. 3 to 5, the first side portion 25 has a magnetic disk 44 embedded within its rear face such that the disk's front face lies within the first recess 26 and the disk's rear face is exposed to the exterior of the first side portion 25 at its rear face. FIG. 5 shows a cross section of the first side portion 25 along the line V-V. It will be appreciated that the second side portion 27 has a corresponding magnetic disk 46 (not shown) similar to the disk 44 and thus the details thereof need not be reiterated.

One or both of the disks 44, 46 or one or both of the respective pins 40, 42 are a magnet, the other being made of a magnetizable material so that the disks and pins are attracted to one another and retained by magnetic forces. Preferably both the pins 40, 42 are magnet members themselves. It will be appreciated that the disks 44, 46 are only one arrangement for providing magnetic attraction between frame 12 and attachment 24, and that any other arrangement that provides such attraction may be used. Preferably, the magnetic connection is hidden, at least while the attachment 24 is mounted on the frame 12 (as shown).

Referring now to FIG. 6, the attachment 24 may be mounted to the eyeglass 10 by first sliding the second pin 42 into the second recess 28. The end face of the second pin 42 will have a magnetic polarity which is opposite that of the magnetic polarity of the inward face of the magnetic disk 46 and thus through magnetic attraction, the end face of the second pin 42 will engage the inward face of the disk 46. The second plate 38 could then be drawn substantially against the front face of the second side portion 27 as the pin 42 slides into the recess 26. The attachment 24 can then be rotated about the second pin 42 until the first pin 40 is aligned with the first recess 26 wherein upon sliding the pin 40 into the recess 26 the attractive magnetic forces between the front face of the pin 40 and the magnetic disk 44 allow the pin 40 to engage the disk 44 and the pin 40 to slide within the recess 26 similar to that described above. As the pins 40, 42 engage the disks 44, 46, the bands 30, 32, the nose plate 34 and the end plates 36, 38 are each aligned with corresponding frame portions and mounted thereon as shown in FIG. 1.

In the example shown in the Figures, since the pins 40, 42 fit within the recesses 26, 28, lateral and vertical movements of the attachment 24 relative to the frame 12 are inhibited. The magnetic attraction between the pins 40, 42 and the disks 44, 46 inhibits fore and aft movements of the attachment 24 relative to the frame 12 during regular use while allowing separation thereof. The frontal attachment shown in the Figures allows a user to readily change attachments 24 by pulling the attachment 24 forward and replacing it with another attachment (not shown) if desired.

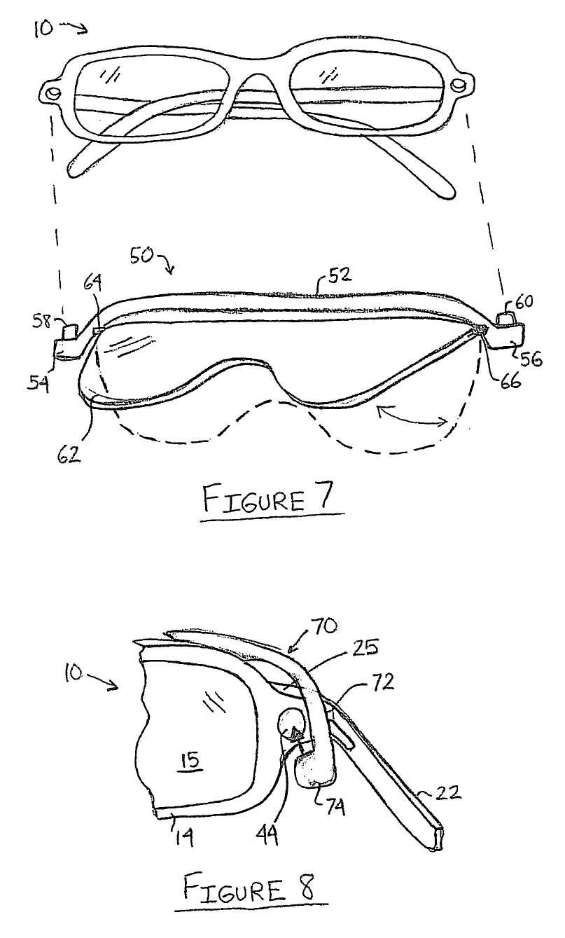

The attachment 24 may embody any shape desirable to the user and can comprise any desirable colour. Therefore a user may own several attachments for a single eyeglass 10 allowing them to interchange the attachments to suit a particular occasion. The recesses 26, 28 also allow other functional attachments such as a “flip-up” lens 50 to be mounted upon the frame 12, as shown in FIG. 7.

The flip-up lens 50 has an upper bar 52 for mounting upon the upper ridge of the frame 12. The bar 52 has a first end plate 54 and a second end plate 56 with respective magnetic pins 58, 60. An auxiliary lens 62 is pivotally mounted to the bar 52 at first and second pivots 64 and 66 defining an axis of rotation. The flip-up lens 50 is mounted upon the frame 12 similar to that described above with respect to the attachment 24 and is moveable between a first position whereby the lens 62 is aligned with lenses 15, 17 and a second position away from the lenses 15, 17. When the lens 50 is seated upon the frame 12, the user can rotate the lens 62 about the axis of rotation thereby “flipping” the lens 62 away from the lenses 15, 17 such that it does not impede vision through lenses 15, 17.

Exposed rear faces of the disks 44, 46 also allow a rear-mounted decorative attachment 70 to be mounted to the rear of the frame 12 as shown in FIG. 8. Such an attachment 70 has at a first end, a first rearwardly extending arm 72 with a first magnetic portion 74 at its distal end. The attachment 70 is mounted upon the eyeglass by hooking the arm 72 over the first side portion 25 placing the magnetic portion 74 near the disk 44. The magnetic polarity of the rear face of the disk 44 would be opposite that of the forward face of portion 74 and therefore when in proximity, the portion 74 would engage the disk 44 through magnetic attraction therebetween. The attachment 70 has a corresponding second arm 73 and second portion 75 (not shown) at a second end which would be mounted to the second side portion 27 in a similar manner as the first end. The rear mounting configuration shown in FIG. 8 may also be used for a rear mounting flip up attachment having an auxiliary lens or any other suitable eyeglass attachment.

It will be appreciated that as an alternative to embedding magnetic disks 44, 46 in the rear faces of the side portions 25, 27, the side portions 25, 27 may be of a magnetic material themselves. It will also be appreciated that the decorative attachment 24 may cover any portion of the outer surface of the frame 12 and shall not be limited to covering only the upper-front portion of the frame 12 as shown herein.

Although the invention has been described with reference to certain specific embodiments, various modifications thereof will be apparent to those skilled in the art without departing from the spirit and scope of the invention as outlined in the claims appended hereto.

What is claimed is:

1 A decorative attachment for an eyeglass, said eyeglass comprising an eyeglass frame containing a pair of lenses separated by a bridge and a pair of side portions at respective ends thereof, said attachment comprising an auxiliary frame sized to cover a portion of said eyeglass frame, and at least one magnetic member for supporting said attachment on said eyeglass through magnetic attraction therebetween.

2. An attachment according to claim 1 wherein said attachment comprises a pair of rearwardly protruding magnetic pins, said pins sized to fit in corresponding recessed portions of said side portions.

3. An attachment according to claim 1 wherein said attachment comprises a pair of rearwardly extending arms having magnetic portions, said attachment being shaped to align said magnetic portions with rearwardly facing surfaces of respective ones of said side portions for magnetic attraction therebetween.

4. An attachment according to claim 1 wherein said auxiliary frame comprises an auxiliary lens pivotally connected thereto, said auxiliary lens moveable between a first position wherein said auxiliary lens is aligned with said pair of lenses and a second position wherein said auxiliary lens is away from said pair of lenses.

5. An eyeglass device comprising a primary frame containing a pair of lenses separated by a bridge and a pair of side portions at respective ends of said primary frame, and a decorative attachment having an auxiliary frame sized to cover a portion of said primary frame and at least one magnetic member for supporting said attachment on said primary frame through magnetic attraction therebetween.

6. An eyeglass device according to claim 5 wherein each said side portion comprises a recessed portion for receiving corresponding magnetic pins protruding rearwardly from said auxiliary frame, said recessed portions comprising magnetic members for magnetically attracting said magnetic pins.

7. An eyeglass device according to claim 5 wherein said attachment comprises a pair of rearwardly extending arms having magnetic portions, said attachment being shaped to align said magnetic portions with rearwardly facing surfaces of respective ones of said side portions comprising magnetic members for magnetic attraction therebetween.

8. An eyeglass device according to claim 5 said auxiliary frame comprises an auxiliary lens pivotally connected thereto, said auxiliary lens moveable between a first position wherein said auxiliary lens is aligned with said pair of lenses and a second position wherein said auxiliary lens is away from said pair of lenses.
